(19) United States
(12) Patent Application Publication
(10) Pub. No.: US 2020/0220209 A1
(43) Pub. Date: Jul. 9, 2020

(54) HYBRID CERAMIC ELECTROCHEMICAL CELL STRUCTURE

(71) Applicant: KERACEL, INC., Santa Clara, CA (US)

(72) Inventor: Philip E. Rogren, Santa Clara, CA (US)

(73) Assignee: KERACEL, INC., Santa Clara, CA (US)

(21) Appl. No.: 16/719,185

(22) Filed: Dec. 18, 2019

Related U.S. Application Data
(60) Provisional application No. 62/789,720, filed on Jan. 8, 2019.

(51) Int. Cl. H01M 10/0562; H01M 10/0525; H01M 4/66; H01M 10/0585

(52) U.S. Cl. CPC H01M 10/0562; H01M 10/0525; H01M 2300/0068; H01M 4/668; H01M 10/0585; H01M 4/664

(57) ABSTRACT

A hybrid electrochemical cell is provided. The cell includes two or more electrochemical sub-cells. Each of the electrochemical sub-cells includes an anode receptive space, a cathode receptive space, a separator between the anode receptive space and a cathode receptive space. Any of the materials that are not required to support ion transfer may be replaced with another material engineered to be compatible with the chemistry, sintering properties and mechanical properties of the ceramic electrolyte material. The material is selected to be less expensive and less reactive with the environment than the ceramic electrolyte material.

### PRIORITY

This application claims the benefit of U.S. Provisional Application Ser. No. 62/789,720, entitled “Hybrid Ceramic Electrochemical Cell Structure,” filed Jan. 8, 2019, which is incorporated herein by reference.

### FIELD

The present invention relates to hybrid ceramic electrochemical cell structures.

### BACKGROUND

As more tools and machines move toward electric power, battery technology becomes more important. Today's best batteries still aren't available at price points that make electric vehicles practical for the majority of people and energy storage density is still too low to power our cell phones and other personal electronics as long as we would like without sacrificing size or functionality. The current state-of-the-art, and presumed future of electrochemical storage is lithium ion technology. Lithium ion secondary cells are based on shuttling lithium ions between anode ant cathode through an electrolyte comprised of an organic solvent and a lithium salt. This electrolyte mixture limits the maximum voltage between anode and cathode and as is an extremely volatile component, represents a high fire and explosion danger if the cell is damaged by electrical or mechanical abuse. Efforts incorporated in current commercial lithium ion cells to mitigate the fire danger result in significantly reduced energy storage density and increased cell cost.

Researchers have labored for at least the last ten years to replace the organic solvent-based electrolyte with lithium ion conducting ceramic electrolytes in efforts to eliminate the explosive components. Progress of these efforts has been slow because of the physical and chemical properties of the ceramic electrolyte materials and the difficulty of developing a volume manufacturing process including thin layers of brittle ceramic material. Researchers and a number of institutions including the University of Michigan and the University of Maryland have proposed solid-state batteries based on processes that create integrated solid and porous structures to address some of the performance issues that have plagued conventional assembly approaches.

While these innovations address part of the problem, they do not address the need to integrate the tens to thousands of square centimeters of cell area to produce cells for practical applications. In copending U.S. application Ser. No. 16/262,058, filed on Jan. 30, 2019, titled “Hybrid Solid State Cell with a Sealed Anode Structured,” the entirety of which is hereby incorporated by reference, KeraCel, Inc., of Santa Clara took the porous solid structure a step further, providing a structure and assembly process capable of integrating tens to hundreds of thin sub-cell layers. KeraCel's approach utilizes the ceramic electrolyte material as a separator, the solid portion of a porous membrane, the enclosing walls of the cathode volume, and the enclosing external container for the cell. This is essentially a monolithic exoskeleton of a many layered cell. While this approach works well in addressing the basic requirements for the structural and sealing functions in addition to providing lithium ion conducting electrolyte where needed, the electrolyte is expensive and not optimum for structural and chemical protection of the active components of the cell.

Precisely engineered, lithium ion conducting material are required in the separator and in any material functioning as an electrolyte in a lithium ion cell. In the subject solid-state cells, that material is one of a number of oxide or sulfide ceramics. Currently, the best of those ceramics is an oxide that is difficult and expensive to formulate and is highly reactive with several gases normally abundant in the atmosphere. These properties make it desirable to use these materials only where necessary. KeraCel's manufacturing process is based on high speed additive manufacturing which enables the unique structures necessary to produce cells of high energy and power density. KeraCel's additive manufacturing also allows otherwise unknown flexibility with respect to including multiple materials, in a voxel wise basis, into a structure with little regard to changes in the process to accomplish the inclusion.

### SUMMARY

In accordance with an aspect of the invention, an electrochemical cell is disclosed that includes: at least two electrochemical sub-cells, each of the at least two electrochemical sub-cells including an anode receptive space, a cathode receptive space, a separator between the anode receptive space and the cathode receptive space, an anode current collector, and a cathode current collector; wherein portions of the at least two electrochemical sub-cells that are not required to support ion transfer comprise a replacement material different than the material of the portions of the at least two electrochemical sub-cells required to support ion transfer.

The anode receptive space and separator may include a lithium ion conducting solid electrolyte material. The lithium ion conducting solid electrolyte material may be a ceramic electrolyte. The lithium ion conducting solid electrolyte material may be lithium lanthanum zirconate. The anode current collector and the cathode current collector may be an electron conducting material. The cathode receptive space may be an open volume.

The anode receptive space and separator may include a lithium ion conducting solid electrolyte material, the anode current collector and the cathode current collector may include an electron conducting material, and the cathode receptive space may include an open volume. The lithium ion conducting solid electrolyte material may be a ceramic electrolyte. The lithium ion conducting solid electrolyte material may be lithium lanthanum zirconate.

The electrochemical cell may further include a cell wall. The cell wall may include a ceramic material different than materials of the at least two chemical sub-cells. The ceramic material may be compatible with the materials of the at least two chemical sub-cells with respect to chemistry, sintering properties and thermal expansion. The ceramic material may be robust with respect to exterior physical forces and stability. The cell wall may form a hermetic seal around the at least two electrochemical sub-cells.

The electrochemical cell may further include a plurality of cathode ports in communication with the cathode spaces in the cell housing.

The cell wall may be in intimate contact with the anode receptive space, the cathode receptive space, the separator, the anode current collector, and the cathode current collector.

The cell wall may provide mechanical support for the at least two electrochemical sub-cells to maintain spacing of adjacent ones of the plurality of sub-cells by fixing a thickness of the cathode space.

The lithium ion conducting solid electrolyte material further may include a metal additive selected from the group consisting of aluminum, tantalum, niobium, gallium and calcium.

The replacement material may be a ceramic material.

The replacement material may be one or more ceramics selected from the group consisting of alumina (Al₂O₃), zirconia (ZrO₂), magnesia (MgO), silica (SiO₂), calcia (CaO), yitria (Y₂O₃) or carbides.

In accordance with another aspect of the invention, an electrochemical cell is disclosed that includes: at least two electrochemical sub-cells, each of the at least two electrochemical sub-cells including an anode receptive space, a cathode receptive space, a separator between the anode receptive space and the cathode receptive space, an anode current collector, and a cathode current collector, wherein the anode receptive space and separator comprise a lithium ion conducting solid electrolyte material; and an exterior wall surrounding the at least two electrochemical sub-cells, wherein the exterior wall comprises a replacement material wherein the replacement material comprises one or more ceramics selected from the group consisting of alumina (Al₂O₃), zirconia (ZrO₂), magnesia (MgO), silica (SiO₂), calcia (CaO), yitria (Y₂O₃) or carbides.

The lithium ion conducting solid electrolyte material may be lithium lanthanum zirconate.

### BRIEF DESCRIPTION OF THE DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings.

FIG. 1 illustrates an exemplary solid-state cell in accordance with an embodiment of the disclosure.

FIG. 2 illustrates an integrated framework of the exemplary solid-state cell of FIG. 1 in accordance with an embodiment of the disclosure.

### DETAILED DESCRIPTION

The present invention is described with reference to the attached figures, where like reference numerals are used throughout the figures to designate similar or equivalent elements. The figures are not drawn to scale, and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present disclosure provides a more cost effective and more robust solution to the sealing and mechanical requirements for solid-state lithium ion cells. In some embodiments, any of the material included in the monolithic exoskeleton that is not required to support ion transfer may be replaced with a second material engineered to be compatible with the chemistry, sintering properties and mechanical properties of the ceramic electrolyte material. For example, the exterior walls surrounding the stack of sub-cells may be made of the second material. In some embodiments, the second material may be chosen to be less expensive and less reactive with the environment than the ceramic electrolyte material.

In general, the porous material in the anode region and the separator are made of the first, ceramic electrolyte material. In one embodiment, the first ceramic electrolyte material is a lithium lanthanum zirconate (LLZO) with additives of metals such as but not limited to aluminum, tantalum, niobium, gallium and calcium.

In another embodiment, more than one material may be used as the second, replacement material for the first, ceramic electrolyte material in non-ion conducting portions of the cell structure.

In some embodiments, the second and/or third replacement materials may be ceramics such as but not limited to alumina (Al₂O₃), zirconia (ZrO₂), magnesia (MgO), silica (SiO₂), calcia (CaO), yitria (Y₂O₃) or carbides, or combinations of these materials, or the listed materials or combinations of the listed materials with other additives.

In some embodiments, the hybrid structure may be created in an additive manufacturing process wherein all of the materials are assembled in a predetermined arrangement as precursors of the final materials. The precursors may be combinations of the final materials and vehicles or additives to facilitate deposition and fixing in place of the deposited materials or they may be combinations of materials that will react in a subsequent thermal treatment to produce the final materials. In the case of reactive material precursors, the deposited materials may also contain vehicles and additives to facilitate deposition and fixing in place. The additive manufacturing may incorporate 3D printing of multiple materials to form the final hybrid structure and may also incorporate a thermal treatment after the hybrid structure has been fully assembled. The thermal treatment may sinter all of the materials of the hybrid structure to a predetermined condition of density and chemical properties, producing a monolithic, but multi materials integrated structure.

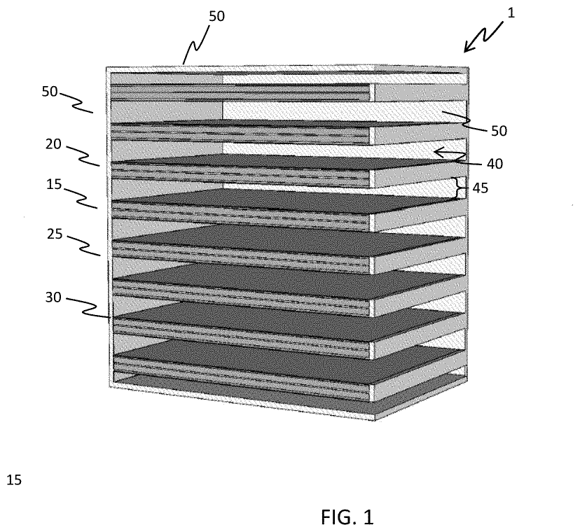

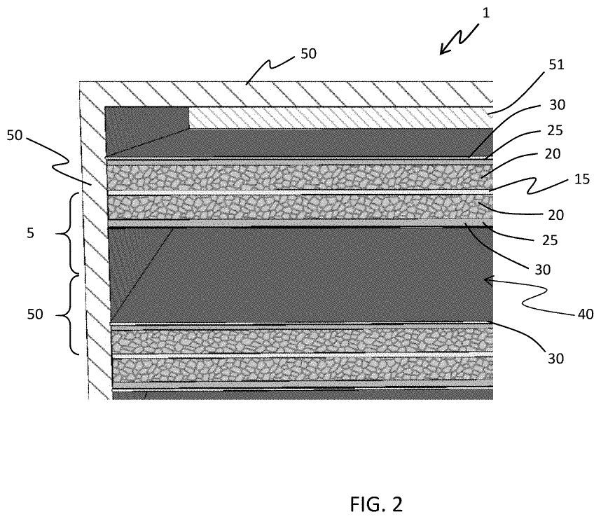

FIG. 1 depicts a cross section of an integrated hybrid structure 1 in accordance with embodiments of the invention. As shown in FIG. 2, the integrated hybrid structure 1 has a plurality of electrochemical sub-cells 5 integrated into a monolithic and multi-material unit. As shown in FIG. 2, each of the plurality of sub-cells 5 includes an anode space 20, a cathode space 40, a separator 25, an anode current collector 15, and a cathode current collector 30. Each of the constituents may have a sheet-like structure.

As shown in FIGS. 1 and 2, the constituent sheet components of the sub cells are disposed in direct intimate contact with adjacent constituents, along their width and breadth. In some embodiments, as shown in FIG. 2, the plurality of sub cells 5 are arranged such that anodes spaces 20 of adjacent sub cells 5 are separated only by anode current collector 15 and a single cathode space 40. The single cathode space 40 is designed to be sufficient to serve two sub cells 5 and is shared by two adjacent sub-cells 5. In this embodiment, the cathode space may comprise two cathode current collectors 30, arranged adjacent to separators 25 of the two adjacent sub-cells 5. The integrated plurality of sub-cells 1 may further comprise an electrical connection between all of the anode current collectors 15, and an electrical connection between all of the cathode current collectors 30. This arrangement may thus be a series electrical configuration. As shown in FIG. 2, the integrated structure of the plurality of sub-cells 1 is surrounded by a cell wall 50 surrounding at least 90% of the periphery of the integrated plurality of sub-cells 1.

In some embodiments, the anode space and the separator of each of the plurality of sub cells 5 may include a lithium ion conducting solid electrolyte material. The anode current collector 15 and the cathode current collector 30 may include an electron conducting material, and the cathode space 40 is an open volume.

In some embodiments, the cell wall 50 may be a ceramic material that is a different chemistry than the sub cell components. The cell wall 50 material may be chosen to be compatible with the sub cell 5 component materials with respect to chemistry, sintering properties and thermal expansion. The material of cell wall 50 may be further chosen to be robust with respect to exterior physical forces and stability in common environments. The material used in the cell wall 50 may be further chosen to form a hermetic seal around the integrated plurality of sub cells 1 and to be inexpensive compared to the solid electrolyte material of the separators 15 and the anode space 20.

With reference to FIG. 1, in some embodiments, the cell wall 50 surrounds and seals all of the integrated plurality of sub cells 1 except for cathode ports 45 allowing access to the cathode spaces 40 from outside the plurality of integrated sub-cells 1. The cell wall 50 is in intimate contact with the components of sub cells 5 and providing mechanical support for each of the plurality of sub-cells 5 to maintain spacing of adjacent sub-cells one to another by fixing the thickness of the cathode space.

In some embodiments, the integrated hybrid structure 1 is created in an additive manufacturing process in which the constituents of each of the components is 3D printed in a predetermined order and pattern. The materials of the 3D printed structure may be precursors of the final materials intended for a predetermined portion of the integrated hybrid structure 1 and is converted to the final predetermined properties by a thermal treatment of the fully assembled integrated hybrid structure 1 after a multi-material 3D printing process. In one embodiment, the thermal treatment is a sintering process predetermined to convert all of the constituent materials to their desired final physical properties.

While some embodiments have been shown and described, it will be obvious to those skilled in the relevant arts that changes and modifications may be made without departing from the invention in its broader aspects. Therefore, the aim in the appended claims is to cover all such changes and modifications that fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

The terminology used herein is for the purpose of describing particular embodiments only and is not intended to limit the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

1. An electrochemical cell comprising:
at least two electrochemical sub-cells, each of the at least two electrochemical sub-cells including an anode receptive space, a cathode receptive space, a separator between the anode receptive space and the cathode receptive space, an anode current collector, and a cathode current collector;
wherein portions of the at least two electrochemical sub-cells that are not required to support ion transfer comprise a replacement material different than the material of the portions of the at least two electrochemical sub-cells required to support ion transfer.

2. The electrochemical cell of claim 1, wherein the anode receptive space and separator comprise a lithium ion conducting solid electrolyte material.

3. The electrochemical cell of claim 2, wherein the lithium ion conducting solid electrolyte material comprises a ceramic electrolyte.

4. The electrochemical cell of claim 3, wherein the lithium ion conducting solid electrolyte material comprises lithium lanthanum zirconate.

5. The electrochemical cell of claim 1, wherein the anode current collector and the cathode current collector comprise an electron conducting material.

6. The electrochemical cell of claim 1, wherein the cathode receptive space comprises an open volume.

7. The electrochemical cell of claim 1, wherein the anode receptive space and separator comprise a lithium ion conducting solid electrolyte material, the anode current collector and the cathode current collector comprise an electron conducting material, and the cathode receptive space comprises an open volume.

8. The electrochemical cell of claim 7, wherein the lithium ion conducting solid electrolyte material comprises a ceramic electrolyte.

9. The electrochemical cell of claim 8, wherein the lithium ion conducting solid electrolyte material comprises lithium lanthanum zirconate.

10. The electrochemical cell of claim 1, further comprising a cell wall.

11. The electrochemical cell of claim 10, wherein the cell wall comprises a ceramic material different than materials of the at least two chemical sub-cells.

12. The electrochemical cell of claim 11, wherein the ceramic material is compatible with the materials of the at least two chemical sub-cells with respect to chemistry, sintering properties and thermal expansion.

13. The electrochemical cell of claim 11, wherein the ceramic material is robust with respect to exterior physical forces and stability.

14. The electrochemical cell of claim 10, wherein the cell wall forms a hermetic seal around the at least two electrochemical sub-cells.

15. The electrochemical cell of claim 14, further comprising a plurality of cathode ports in communication with the cathode spaces in the cell housing.

16. The electrochemical cell of claim 10, wherein the cell wall is in intimate contact with the anode receptive space, the cathode receptive space, the separator, the anode current collector, and the cathode current collector.

17. The electrochemical cell of claim 10, wherein the cell wall provides mechanical support for the at least two electrochemical sub-cells to maintain spacing of adjacent ones of the plurality of sub-cells by fixing a thickness of the cathode space.

18. The electrochemical cell of claim 4, wherein the lithium ion conducting solid electrolyte material further comprises a metal additive selected from the group consisting of aluminum, tantalum, niobium, gallium and calcium.

19. The electrochemical cell of claim 1, wherein the replacement material comprises a ceramic material.

20. The electrochemical cell of claim 19, wherein the replacement material comprises one or more ceramics selected from the group consisting of alumina (Al₂O₃), zirconia (ZrO₂), magnesia (MgO), silica (SiO₂), calcia (CaO), yitria (Y₂O₃) or carbides.

21. An electrochemical cell comprising:
at least two electrochemical sub-cells, each of the at least two electrochemical sub-cells including an anode receptive space, a cathode receptive space, a separator between the anode receptive space and the cathode receptive space, an anode current collector, and a cathode current collector,
wherein the anode receptive space and separator comprise a lithium ion conducting solid electrolyte material; and
an exterior wall surrounding the at least two electrochemical sub-cells, wherein the exterior wall comprises a replacement material wherein the replacement material comprises one or more ceramics selected from the group consisting of alumina (Al₂O₃), zirconia (ZrO₂), magnesia (MgO), silica (SiO₂), calcia (CaO), yitria (Y₂O₃) or carbides.

22. The electrochemical cell of claim 21, wherein the lithium ion conducting solid electrolyte material comprises lithium lanthanum zirconate.
